(19) United States
(12) Patent Application Publication
(10) Pub. No.: US 2010/0318784 A1
(43) Pub. Date: Dec. 16, 2010

(54) CLIENT IDENTIFICATION FOR TRANSPORTATION LAYER SECURITY SESSIONS

(75) Inventors: Sandeep RAO, Bangalore (IN); Daniel G. WING, San Jose, CA (US); Scott Roy FLUHRER, North Attleboro, MA (US)

Correspondence Address: HICKMAN PALERMO TRUONG & BECKER, LLP, 2055 GATEWAY PLACE, SUITE 550, SAN JOSE, CA, 95110, US

(73) Assignee: CISCO TECHNOLOGY, INC., San Jose, CA (US)

(21) Appl. No.: 12/481,725

(22) Filed: Jun. 10, 2009

(51) Int. Cl. H04L 29/06; G06F 15/16; H04L 9/32

(52) U.S. Cl. 713/151; 726/10; 713/171; 713/168; 726/4; 726/11

(57) ABSTRACT

Systems, methods, and other embodiments associated with client identification for transportation layer security sessions are described. One example method includes monitoring a first transportation layer security (TLS) communication between a server and a client. The example method may also include interrupting the first TLS communication and causing the first TLS communication to be interrupted. The example method may also include initiating a second TLS communication with a client side device. The second TLS communication may request a certificate from the client side device. The certificate may include secure information that identifies the client. The example method may also include receiving the certificate from the client side device. The example method may also include authenticating the client, the client side device, and so on, based, at least in part, on the certificate.

### BACKGROUND

Transport Layer Security (TLS) is a cryptographic protocol that provides data integrity for transmission control protocol/internet protocol (TCP/IP) networks. TLS is used in applications that include web browsers, email applications, instant messaging applications, and applications that implement voice over internet protocol (VoIP). TLS may encrypt data associated with a layer four (L4) transport protocol for use in end-to-end connections across a network. Encryption may prevent others from viewing confidential information passed through a non-secure network. Traditionally, TLS has also authenticated a server for a client that wishes to share sensitive information with the server. TLS authenticates the server by verifying the identity of the server. IKE is a cryptographic protocol used primarily to establish keys for another protocol, most commonly IPsec. IPsec is often used with VPN tunnels. IKE, as used herein, may include IKEv2.

TLS encryption and TLS authentication may be used with hypertext transfer protocol (HTTP) to create an HTTP over a secure socket layer (HTTPS) connection. Secure HTTPS communications may prevent eavesdropping, message tampering, and message forgery by performing authentication and encryption. Additionally, the TLS encryption and TLS authentication may be performed by the client, a firewall associated with the client, a networking device associated with the client, a client side trust agent, and so on.

The server TLS authentication may allow the client to perform trusted communications with the server. This may facilitate passing secure information from the client to the server. For example, a client may wish to purchase an item on an internet site. It may be wise for the client to verify that the server is legitimate (e.g., authenticate the server) before passing credit card data or other personal information to the server. TLS server authentication may provide the necessary verification to enhance trust. Traditional TLS embodiments may encrypt data to ensure that data is not read by others while passing through an unsecure network. TLS may also verify message sources to prevent hijacking data and/or altering data.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an example method associated with client identification for transportation layer security sessions.

FIG. 2 illustrates another example method associated with client identification for transportation layer security sessions.

FIG. 3 illustrates another example method associated with client identification for transportation layer security sessions.

FIG. 4 illustrates another example method associated with client identification for transportation layer security sessions.

FIG. 5 illustrates an example apparatus associated with client identification for transportation layer security sessions.

FIG. 6 illustrates another example apparatus associated with client identification for transportation layer security sessions

FIG. 7 illustrates an example networking environment including TLS protocol exchanges.

FIG. 8 illustrates another example networking environment including TLS protocol exchanges

FIG. 9 illustrates an example computing environment in which example systems and methods, and equivalents, may operate.

FIG. 10 illustrates an example environment where client identification for transport layer security involves an identity provider and an identity consumer processing an Internet Key Exchange (IKE).

FIG. 11 illustrates actions associated with monitoring IKE negotiations.

FIG. 12 illustrates actions associated with monitoring IKE negotiations.

### BRIEF OVERVIEW

While the TLS protocol itself allows the client and server to both exchange a certificate, typical use of TLS does not verify the identity of a client and/or give the client identity to the server. This may prevent the server from making decisions that allow sharing of confidential information with the client. TLS client authentication may make the server more secure. TLS client authentication may allow servers to pass confidential information to clients with an increased level of trust.

Client authentication may be performed at L4 by intercepting a typical first TLS handshake between the client and a server. The typical first TLS handshake may be temporarily interrupted. The typical first TLS handshake may not pass identity information associated with the client to server side devices. However, a special second TLS communication may be initiated to facilitate transferring identity information associated with the client. The identity information may be used by the server and/or server side devices to make an access control decision. The access control decision may grant or block access requests for confidential information by the client. The confidential information may be associated with the server.

The special second TLS communication, which may also be a TLS handshake, may be initiated between an authentication via monitoring (AvM) device and a client side device. The AvM device may be, more generically, an identity consumer. This second TLS communication may be performed in the same TCP connection as the first TLS communication. The client side device may be an Ethernet switch associated with the client, a security agent associated with the client, a trust agent associated with the client, and so on. The identity consumer may be a firewall associated with the server, a networking device associated with the server, an application executing in the server, and so on. The client side device may have recorded an identity information associated with the identity of the client during the first handshake or a previous handshake. The special second TLS handshake between the client side device and the identity consumer may securely communicate the identification information associated with the client (e.g., certificate, public key, username, software versions) to the identity consumer. The identity consumer may use the identification information to determine whether the client will be allowed to connect to the server. Additionally, the identity consumer may determine the level of access granted to the client when accessing the server. For example, the identity consumer may determine whether to block a data flow from the client, to pass data from the client, to inspect data from the client, to rate limit data from the client, to apply other access controls to data from the client, and so on.

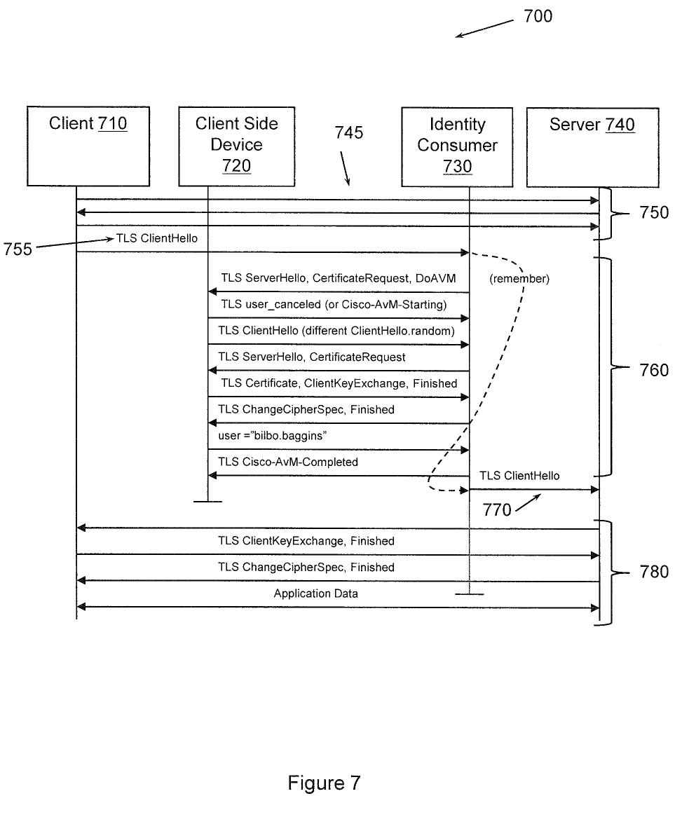

By way of illustration, a TLS identity provider (e.g., client side device) may intercept a first TLS connection. The first TLS connection may include a TLS ClientHello. The TLS identity provider may record the TLS ClientHello and forward the TLS ClientHello to an upstream device (e.g., TLS identity consumer). The TLS identity provider may be an Ethernet switch, a security agent, a trust agent, a device associated with a client, software executing in the client, and so on (e.g., client side device 720, FIG. 7). The TLS identity provider may authenticate an associated endpoint (e.g., the client), which may include recording a secure credential associated with the endpoint during the first TLS connection (e.g., first TLS communication 750, FIG. 7), a TLS handshake, and so on. In traditional embodiments, the secure credential may not be shared with devices associated with the server.

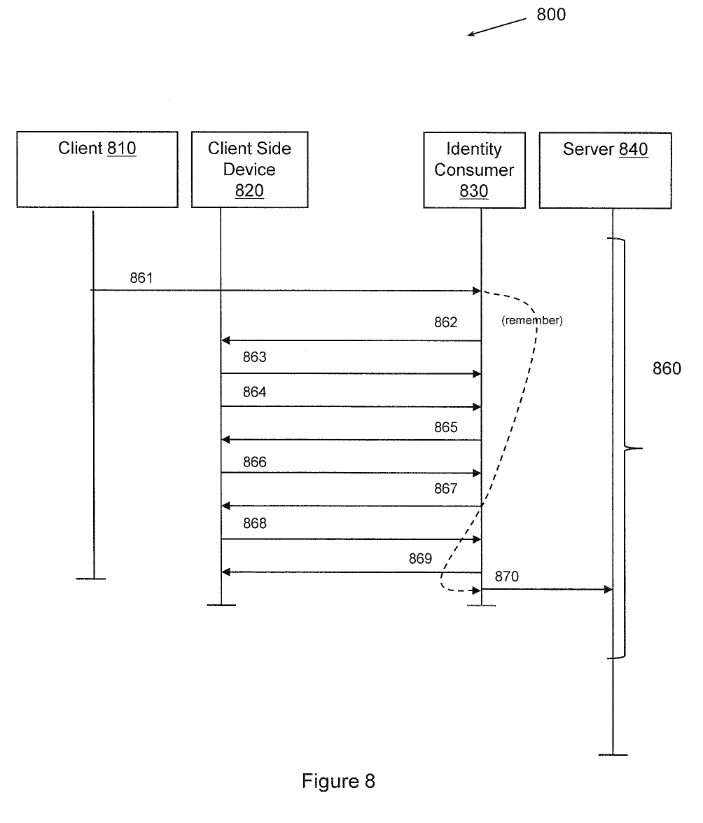

The TLS ClientHello may reach a TLS identity consumer. The TLS identity consumer may be, for example, an AvM device, a networking device associated with a server, a firewall, and so on. These may be referred to generically as identity consumers. The TLS identity consumer may be interested in acquiring the secure credential associated with the endpoint (e.g., client). The TLS identity consumer may hold the TLS ClientHello (e.g., TLS ClientHello 861, FIG. 8) in order to defer the TLS connection with the server. The TLS identity consumer may then respond with a special ServerHello (e.g., TLS ServerHello 862, FIG. 8) that may contain a special code that identifies the ServerHello as being associated with the TLS identity consumer (e.g., server side device). The special code may be a two byte code, a four byte code, collections of bits, and so on. This special ServerHello may be sent in the same TCP connection as the first TLS communication.

The TLS identity provider may negotiate a second TLS connection (e.g., second TLS communication 760, FIG. 7) upon receiving the special ServerHello from the TLS identity consumer. The second TLS connection may include the TLS identity provider sending the secure credentials associated with the client to the TLS identity consumer. These credentials might be the certificate (as part of the TLS handshake) or other information exchanged after the TLS session is established. The second TLS connection may then be closed. The TLS identify consumer now has enough information to authenticate and authorize the TLS client. The TLS identity consumer may use the secure credentials associated with the client to decide whether the flow between the client and the server should be blocked, passed, inspected, rate limited, and so on. If the TLS identity consumer decides to authorize the TLS client, it may release the TLS ClientHello that it held previously to the server. This may include, for example, forwarding the TLS ClientHello 870 (FIG. 8). The TLS identity consumer may initiate communications with the client and/or the TLS identity provider to correct and/or continue the first TLS communications (e.g., completion TLS communication 780 of FIG. 7).

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

“Signal”, as used herein, includes but is not limited to, electrical signals, optical signals, analog signals, digital signals, data, computer instructions, processor instructions, messages, a bit, a bit stream, or other means that can be received, transmitted and/or detected.

“Software”, as used herein, includes but is not limited to, one or more executable instruction that cause a computer, processor, or other electronic device to perform functions, actions and/or behave in a desired manner. “Software” does not refer to stored instructions being claimed as stored instructions per se (e.g., a program listing). The instructions may be embodied in various forms including routines, algorithms, modules, methods, threads, and/or programs including separate applications or code from dynamically linked libraries.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

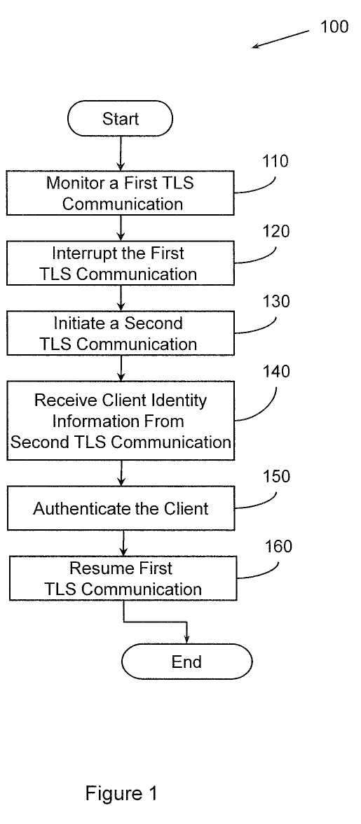

FIG. 1 illustrates a method 100 associated with client identification for transportation layer security sessions. Method 100 may include, at 110, monitoring a first transportation layer security (TLS) communication. The first TLS communication may be between a server and a client. The transport layer is part of an open system interconnection (OSI) model that defines a networking framework for implementing protocols in seven layers. Control in this model is passed from one layer to the next, starting at the seventh layer and proceeding to the first layer. The layers from the seventh to the first are application, presentation, session, transport, network, data-link, and physical. The fourth layer (L4) is the transport layer.

Method 100 may also include, at 120, interrupting the first TLS communication. Interrupting the first TLS communication at 120 may cause the first TLS communication to be interrupted. The interruption may be performed by an identity consumer (e.g., authentication via monitoring (AvM) device) that may be associated with the server. The identity consumer may execute method 100. The identity consumer may record the first TLS communication (e.g., TLS ClientHello) in a data store and forward the first TLS communication to the server at a later time.

“Data store”, as used herein, refers to a physical and/or logical entity that can store data. A data store may be, for example, a database, a table, a file, a list, a queue, a heap, a memory, a register, and so on. In different examples, a data store may reside in one logical and/or physical entity and/or may be distributed between two or more logical and/or physical entities. In some examples, “database” is used to refer to a table. In other examples, “database” may be used to refer to a set of tables. In still other examples, “database” may refer to a set of data stores and methods for accessing and/or manipulating those data stores.

Method 100 may also include, at 130, initiating a second TLS communication. The second TLS communication may be with a client side device. The second TLS communication may be inside the same TCP connection as the first TLS communication. The second TLS communication may request a certificate from the client side device. The certificate may include secure information that identifies the client. After the TLS session is established, additional information about the client might be transmitted or requested. In one embodiment, the first TLS communication is a TLS handshake. The second TLS communication may also be a TLS handshake.

In one embodiment, the client side device may be the client, a networking device associated with the client, an Ethernet switch associated with the client, a security agent associated with the client, a security trust agent associated with the client, and so on. In one embodiment, the certificate may be a public key, a private key, a certificate issued by a third party that can be validated by the server or the identity consumer, a public key associated with the client side device, a private key associated with the client side device, and so on.

Method 100 may also include, at 140, receiving the certificate from the client side device. Method 100 may also include, at 150, authenticating the client. Authenticating the client at 150 may include authenticating the client, the client side device, and so on, based, at least in part, on the certificate received at 140. In different embodiments, the method 100 may be performed by identity consumers including, for example, the server, by an application executing in the server, by a firewall, by an authentication via monitoring (AvM) device associated with the server, and so on. Authenticating the client at 150 may include using the secure credentials associated with the client to decide whether the data flow between the client and the server should be blocked, passed, inspected, rate limited, applied against other access controls, and so on. Authenticating at 150 may depend upon, for example, the client being on a list of trusted clients, the client being verified by a third party certificate provider, and so on.

Method 100 may also include, at 160, resuming the first TLS communication. Thus, one skilled in the art will appreciate that the first TLS communication is not abandoned, but rather is interrupted while client identification is performed to create transport layer security sessions.

While FIG. 1 illustrates various actions occurring in serial, it is to be appreciated that various actions illustrated in FIG. 1 could occur substantially in parallel. By way of illustration, a first process could monitor a first TLS communication at 110, a second process could interrupt the first TLS communication at 120, a third process could initiate a second TLS communication at 130, a fourth process could receive the certificate from the client side device at 140, and a fifth process could authenticate at 150. While five processes are described, it is to be appreciated that a greater and/or lesser number of processes could be employed and that lightweight processes, regular processes, threads, and other approaches could be employed.

In one example, executable instructions associated with performing a method may embodied as logic encoded in one or more tangible media for execution. When executed, the instructions may perform a method. Thus, in one example, logic encoded in one or more tangible media may store computer executable instructions that if executed by a machine (e.g., processor) cause the machine to perform method 100. While executable instructions associated with the above method are described as being embodied as logic encoded in one or more tangible media, it is to be appreciated that executable instructions associated with other example methods described herein may also be stored on a tangible media.

A “tangible media”, as used herein, refers to a medium that stores signals, instructions and/or data. A tangible media may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a tangible media may include, but are not limited to, a floppy disk, a flexible disk, a hard disk, a magnetic tape, other magnetic medium, an application specific integrated circuit (ASIC), a compact disk CD, other optical medium, a random access memory (RAM), a read only memory (ROM), a memory chip or card, a memory stick, and other media from which a computer, a processor or other electronic device can read.

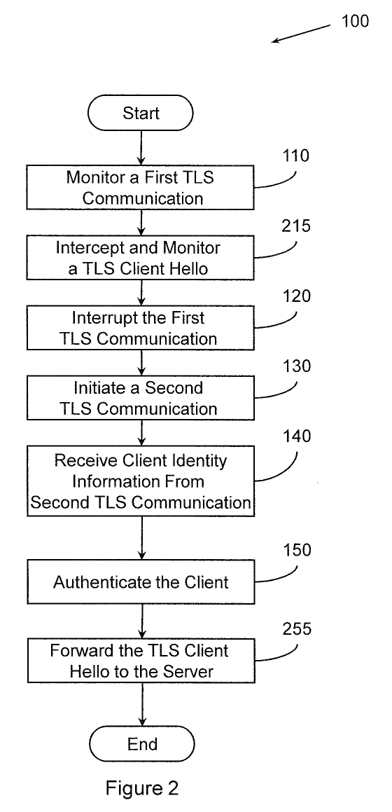

FIG. 2 illustrates another embodiment of method 100. This embodiment of method 100 may also include, at 215, intercepting and monitoring a TLS ClientHello. The TLS ClientHello may be intercepted and monitored at 215 when the TLS ClientHello is sent from the client to the server.

In one embodiment, method 100 may also include, at 255, forwarding the TLS ClientHello to the server. Forwarding the TLS ClientHello at 255 may continue the first TLS communication between the client and the server. Forwarding the TLS ClientHello to the server at 255 may facilitate continuing and/or repairing the first TLS communication associated with action 110. Repairing the data flow may be needed due to interruption of the first TLS handshake. Additionally, packets communicated between the client side device and the device performing method 100 (e.g., identity consumer, AvM device) may not have been sent to the server. The need to repair the data flow including the first TLS communication may depend on whether the method 100 is performed by a device outside of the server or whether the method 100 is performed by the server.

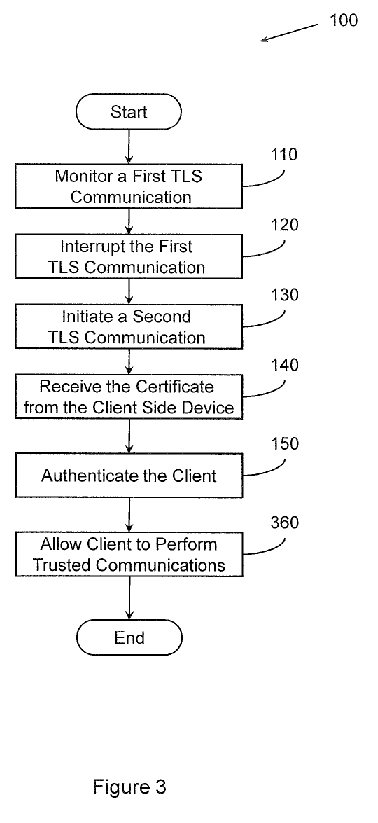

FIG. 3 illustrates another embodiment of method 100. This embodiment of method 100 may also include, at 360, allowing the client to perform trusted communications. Trusted communications may be performed with the server. Trusted communications may include the server sending trusted information to the client. The server may trust the client because the client has been authenticated at 150 by method 100. Authenticating at 150 may depend upon conditions. For example, the client may be on a list of approved clients, the client may have a certificate that may be verified by a third party, and so on. Trusted information may include, for example, confidential information, personal information, credit card information, and so on. The trusted information may be sent back to the client from the server for verification purposes.

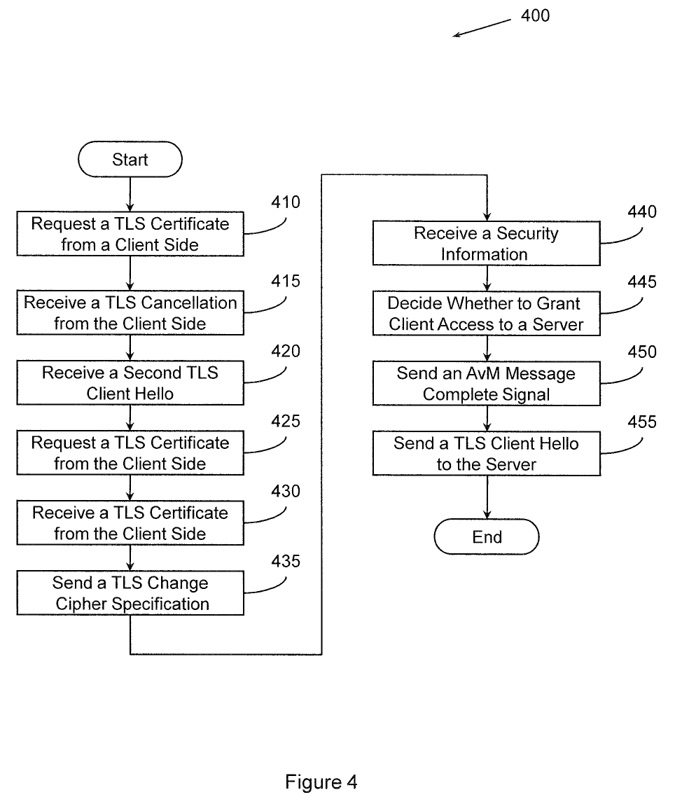

FIG. 4 illustrates a method 400 associated with client identification for transportation layer security sessions. Method 400 may be employed in the example networking environments that include the TLS protocol exchanges illustrated in FIGS. 7 and 8.

Method 400 may include, at 410, requesting a TLS certificate from a client side. The client side may be associated with a client. The TLS certificate may be requested from the client side at 410 upon detecting a first transport layer security (TLS) ClientHello from the client. Requesting the TLS certificate at 410 may include providing and/or sending a TLS ServerHello as part of the request. The client side may be a client application, the client, an Ethernet switch, a security agent, a trust agent, and so on. The TLS certificate may identify the client with a public key, a private key, a key issued by a trusted third party, and so on. The client may be an unmodified application that has not been updated to identify the client. For example, the client may include conventional TLS software that typically authenticates the server but not the client. Method 400 may be a software patch that may be added to TLS software executing on the identity consumer. The software patch may allow method 400 to operate with conventional TLS software and allow method 400 to authenticate a client for a server.

Method 400 may also include, at 415, receiving a TLS Cancellation from the client side. The TLS Cancellation from the client side may be received at 415 in response to requesting a TLS certificate from the client side at 410.

Method 400 may also include, at 420, receiving a second TLS ClientHello. The second TLS ClientHello may be received at 420 from the client side. The second TLS client may be received at 420 in response to requesting a TLS certificate from the client side at 410.

Method 400 may also include, at 425, requesting a TLS certificate from the client side. The TLS certificate from the client side at 425 may be requested at 425 upon receiving the second TLS ClientHello at 420. Requesting the TLS certificate from the client side at 425 may include sending a TLS ServerHello to the client side as part of the request or as the entire request.

Method 400 may also include, at 430, receiving a TLS certificate from the client side. The TLS certificate received from the client side at 430 may be received in response to requesting a TLS certificate from the client side at 425.

Method 400 may also include, at 435, sending a TLS ChangeCipher specification. The TLS ChangeCipher specification sent at 435 may be sent to the client side. The TLS ChangeCipher specification sent at 435 may be sent upon receiving the TLS certificate from the client side at 430.

Method 400 may also include, at 440, receiving a security information. The security information may be associated with the client. The security information received at 440 may be received in response to sending the TLS ChangeCipher specification at 435.

Method 400 may also include, at 445, deciding whether to grant the client access to a server. The decision that grants the client access to the server at 445 may be based, at least in part, on the security information and the TLS certificate. Deciding whether to grant the client access to the server at 445 may be performed in response to receiving the security information at 440.

When the identity consumer is an AvM device, method 400 may also include, at 450, sending an AvM message complete signal. The AvM message complete signal may be sent at 450 to the client side. The AvM message complete signal may be sent at 450 upon deciding whether to grant the client access to the server at 445. More generically, an authentication complete message may be sent to an identity consumer.

Method 400 may also include, at 455, sending a TLS ClientHello to the server. The TLS ClientHello may be sent to the server at 455 upon sending the AvM message complete signal to the client side at 450. However, the TLS ClientHello may be sent to the server at 455 upon deciding whether to grant the client access to a server at 445.

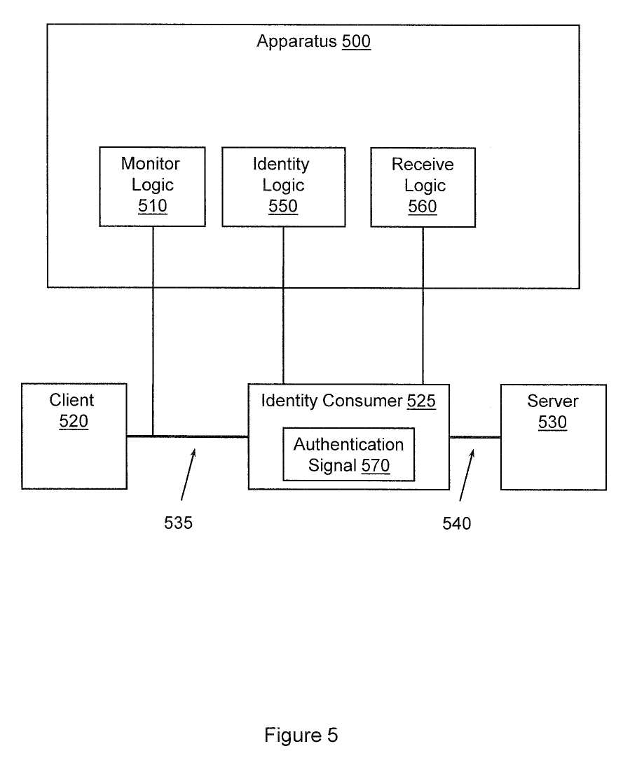

FIG. 5 illustrates an apparatus 500 associated with client identification for transportation layer security sessions. Apparatus 500 includes a monitor logic 510 to monitor a first transport layer security (TLS) communication between a client 520 and a server 530, and between the client 520 and an identity consumer (e.g., authentication via monitoring (AvM) device) 525 associated with the server 530, and so on. One skilled in the art will realize that the first TLS communications between the client 520 and the server 530 may traverse the identity consumer device 525. For example, the first communication between the client 520 and the server 530 may travel through a first connection 535 to the identity consumer device 525, travel from the identity consumer 525 through a second connection 540 to the server 530. One skilled in the art will realize that the identity consumer 525 may be associated with the server 530, the identity consumer 525 may be software running in the server 530, and so on.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

In one embodiment, the monitor logic 510 may cause the first TLS communication to be interrupted. In one embodiment, the first TLS communication is a TLS handshake. The second TLS communication may also be a TLS handshake.

In one embodiment, the identity consumer 525 is a firewall associated with the server 530. The identity consumer 525 may be located between the apparatus 500 and the server 530. The identity consumer 525 may be located separately from the server 530, in the server 530, and so on.

Apparatus 500 may also include an identity logic 550 to initiate a second TLS communication. The second TLS communication may establish a secure connection between the apparatus 500 and the identity consumer 525. The secure connection may pass an identity information associated with the client 520 to the identity consumer 525. The secure connection may prevent spoofing, message interception, and so on.

In one embodiment, the monitoring logic 510 may collect a first TLS identity information associated with the client 520 from the first TLS communication. In one embodiment, the identity logic 550 may pass the first TLS identity information to the identity consumer 525. The identity consumer 525 may determine whether to grant the client 520 access to the server 530 based, at least in part, on the identity information and/or the first TLS identity information.

Apparatus 500 may also include a receive logic 560 to receive an authentication signal 570 from the identity consumer 525. The authentication signal 570 may be associated with authorizing the client 520 to access the server 530. In one embodiment, the authentication signal 570 is created by the identity consumer 525 based, at least in part, on the identity information and/or the first TLS identity information. The authentication signal 570 may indicate whether the client 520 is authorized to connect to the server 530.

In different embodiments, the apparatus 500 may be a networking device associated with the client 520, may be located in the client 520, may be a firewall protecting the client 520, may be an Ethernet switch, a security agent, a trust agent, and so on. The apparatus 500 may be kernel software on a personal computer (e.g., client) that monitors and/or intercepts TLS communications. The security agent may be a Cisco™ Security Agent and the trust agent may be a Cisco™ Trust agent.

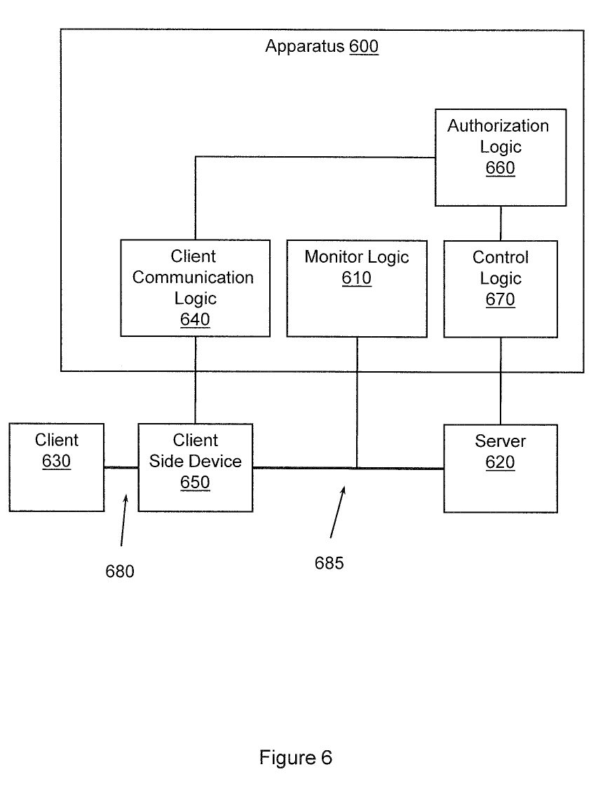

FIG. 6 illustrates an apparatus 600 associated with client identification for transportation layer security sessions. Apparatus 600 includes a monitor logic 610 to monitor a transport layer security (TLS) communication between a server 620 and a client 630. The monitor logic 610 may cause the first TLS communication to be interrupted.

In different embodiments, the apparatus 600 may be a firewall, an AvM device, the server 620, a network switch associated with the server 620, and so on.

Apparatus 600 may also include a client communication logic 640 to initiate a CertificateRequest to a client side device 650 and to receive a certificate from the client side device 650. The certificate may include a secure information that identifies the client 630. The CertificateRequest may be initiated in response to the monitor logic 610 monitoring the TLS communication between the server 620 and the client 630. The secure information may be a public key, a private key, a third party supplied and verifiable certificate, and so on. In one embodiment, the TLS communication is a TLS handshake. The CertificateRequest may be a TLS communication, a TLS handshake, and so on.

In different embodiments the client side device 650 may be the client 630, a firewall protecting the client 630, an Ethernet switch, a security agent, a trust agent, and so on. The client side device 650 may be a device that protects the client 630. The security agent may be a Cisco™ Security Agent and the trust agent may be a Cisco™ Trust agent.

In different embodiments, the client side device 650 may be located in the client 630, in an Ethernet switch, in a security agent, in a trust agent, and so on. The client side device 650 may protect the client 630 by authenticating servers (e.g., server 620) that connect to the client 630.

Apparatus 600 may also include an authorization logic 660 to determine whether the client 630 is authorized to access the server 620 based, at least in part, on the certificate. In one embodiment, the authorization logic 660 is to determine whether the client 630 is granted access to the server 620 based, at least in part, on a TLS information monitored during the TLS communication. The TLS information may be provided by client 630 or client side device 640. One skilled in the art will realize that the TLS information may be from TLS communication that was interrupted.

In one embodiment, the monitor logic 610 is to collect a TLS identity information associated with the client 630 from the TLS communication between the client 630 and the server 620. The authorization logic 660 is to determine whether the client 630 is granted access to the server 620 based, at least in part, on the TLS identity information.

In one embodiment, the authorization logic 660 is to send an authentication signal to the client side device. The authentication signal may indicate to the client side device 650 whether the client 630 is granted access to the server 620. The authentication signal may be similar to authentication signal 570 from FIG. 5.

Apparatus 600 may also include a control logic 670 to selectively control communications between the server 620 and the client 630 based on the authorization granted by the authorization logic 660. Although control logic 670 is depicted as being connected to server 620 in FIG. 6, control logic 670 may also be connected to first connection 680 and/or second connection 685. Additionally, control logic 670 may act as a logic in a firewall, AvM device, and other security device. The logic may authorize traffic that flows to and from the server 620. Control logic 670 may control whether the data traffic between the client and the server is blocked, passed, inspected, rate limited, apply other access controls, and so on.

One skilled in the art will realize that the TLS communication between the client 630 and the server 620 may traverse a client side device 650. One skilled in the art will also realize that the client side device 650, although depicted as separate from the client 630 in FIG. 6, may be in the client 630 and/or part of the client 630. Control logic 670 may be a firewall protecting the server. Control logic 670 may control access to the server 620. One skilled in the art will understand that controlling access to the server 620 may include preventing the server 620 from sharing sensitive information with unauthorized clients (e.g., client 630). The apparatus 600 may be similar to the identity consumer 525 of FIG. 5. One skilled in the art will realize that apparatus 600 may also be placed in-line between the client side device 650 and the server 620 similar to the identity consumer 525 of FIG. 5.

FIG. 7 illustrates an example networking environment including TLS protocol exchanges occurring in the environment. Environment 700 includes a client 710 and a client side device 720 that may be associated with the client 700. The client side device 720 may protect the client 710 from potential threats. Client side device 720 may be an Ethernet switch, a security agent, a trust agent, and so on. Environment 700 may also include an identity consumer device 730 and a server 740. The identity consumer 730 may be a firewall that protects the server 740 from threats.

The client 710, the client side device 720, the identity consumer 730, and the server 740 may all be connected via a network 745. Network 745 may facilitate the exchange of data traffic between components 710, 720, 730, and 740.

The exchange of data traffic may include a first TLS communication 750. The first TLS communication may be similar to the first TLS communication monitored at 110 (FIG. 1), the first TLS communication between a client 520 and a server 530 (FIG. 5), and a TLS communication between a client 630 and a server 620 (FIG. 6). The first TLS communication 750 may be interrupted by the identity consumer 730.

The exchange of data traffic may include a second TLS communication 760. The second TLS communication 760 may be similar to the second TLS communication initiated at 130 (FIG. 1), the second TLS communication initiated by the identity logic 550 (FIG. 5), and the CertificateRequest initiated by the client communication logic 640 (FIG. 6). The second TLS communication 760 may be a TLS exchange to ensure correspondence between an AvM TLS exchange and a Server TLS exchange.

The exchange of data traffic may include a completion TLS communication 780 of the first TLS communication 750. The completion TLS communication 780 may include the identity consumer 730 sending a TLS ClientHello 770 that is associated with a TLS ClientHello 755 that was associated with the interrupted first TLS communication 750.

FIG. 8 illustrates another example networking environment including TLS protocol exchanges occurring in the environment. Environment 800 may include components similar to environment 700. For example, environment 800 may include a client 810, a client side device 820, an identity consumer device 830, a server 840, and a second TLS communication 860. However, FIG. 8 includes additional details associated with the second TLS communication 860.

The second TLS communication 860 may include a TLS ClientHello 861. The TLS ClientHello 861 may be sent from the client 810 to the server 840. However, the TLS ClientHello 861 may be intercepted by the identity consumer 830 before the TLS ClientHello 861 reaches the server 840. The identity consumer 830 may record the TLS ClientHello 861 in a data store for later forwarding to the server 840. For example, the TLS ClientHello 861 may be forwarded to the server 840 at the end of the second TLS communication 860. The TLS ClientHello 861 may specify a list of TLS protocols supported by the client 810, a random number, and a list of suggested ciphers. The TLS ClientHello 861 may also include the session identification from the first TLS communication 750 (FIG. 7). In one embodiment, the TLS ClientHello 861 may not be part of the second TLS communication 860. The TLS ClientHello 861 may be a signal to the identity consumer 830 to start the second TLS communication 860. The TLS ClientHello 861 may be part of the first TLS communication 750 (FIG. 7).

The second TLS communication 860 may include additional exchanges between the client side device 820 and the identity consumer 830. These exchanges transmit a secure information associated with the identity of the client 810. In typical TLS embodiments, the client side device 820 may have the secure information associated with the identity of the client 810. However the secure information may not be shared with the identity consumer 830 and/or the server 840. The second TLS communication 860 may facilitate passing the secure information to the identity consumer 830 to allow the identity consumer 830 to determine whether the client may communicate with the server 840.

The second TLS communication 860 may include a TLS ServerHello and CertificateRequest 862. The identity consumer 830 may send the TLS ServerHello and CertificateRequest 862 to the client side device 820 in response to the TLS ClientHello 861. The TLS ServerHello and CertificateRequest 862 may include data identifying a protocol to be used in communications from the list of protocols in the TLS ClientHello 861. The TLS ServerHello 862 may also include a random number, a cipher, compression processes to use in communications, and the session identification used by the client 810.

The second TLS communication 860 may include a TLS UserCancelled message 863. The TLS UserCancelled massage 863 may be sent from the client side device 820 to the identity consumer 830 to facilitate canceling and/or postponing the first TLS communication 750 (FIG. 7). The TLS UserCancelled message 863 may be sent in response to the TLS ServerHello and CertificateRequest 862.

The second TLS communication 860 may include a second TLS ClientHello 864. The second TLS ClientHello message 864 may be sent by the client side device 820 to the identity consumer 830 to facilitate the second TLS communication 860. The second ClientHello message 864 may be sent in response to the TLS ServerHello and CertificateRequest 862.

The second TLS communication 860 may include a second TLS ServerHello message 865. The second TLS ServerHello message 865 may be sent by the identity consumer 830 to the client side device 820 to complete initializing the second TLS communication 860. The second TLS ServerHello message 865 may be sent in response to the second TLS ClientHello message 864.

The second TLS communication 860 may include a TLS Certificate, TLS ClientKeyExchange, and Finished message 866. The TLS ClientKeyExchange may include a secret code, a public key, and/or nothing. The TLS Finished message 866 may include a hash and media access control (MAC) address associated with the previous TLS requests, messages, and so on. Message 866 may be sent in response to the second TLS ServerHello message 865. Message 866 may be sent from client side device 820 to the identity consumer 830. The identity consumer 830 may attempt to decrypt the TLS Finished message 866 to verify the hash and MAC address.

The second TLS communication 860 may include a TLS ChangeCipher Specification and Finished message 867. Message 867 may be sent from the identity consumer 830 to the client side device 820 in response to message 866. The client side device 820 may attempt to decrypt the Finished message 866 to verify the hash and MAC address.

The second TLS communication 860 may include a User message 868 sent in response to message 867. The User message 868 may be sent from the client side device 820 to the identity consumer 830.

The second TLS communication 860 may include a TLS AvM completed message 869 sent in response to message 868. Message 869 may be sent from the identity consumer 830 to the client side device 820.

The second TLS communication 860 may include forwarding the TLS ClientHello message 870 from the identity consumer 830 to the server 840. Previously, the TLS ClientHello message 870 was sent from the client 810 to the identity consumer 830 (see TLS ClientHello message 861). The TLS ClientHello message 870 may be forwarded in response to receiving message 869. The TLS ClientHello message 870 forwarding may be similar to forwarding the TLS ClientHello to the server at 255 (FIG. 2). The second TLS communication 860 may facilitate the transfer of a client identity information from the client side device 820 to the identity consumer 830. The client identity information may verify the identity of the client 810. This may allow the identity consumer 830 to control whether the client 810 may receive confidential information from the server 840 based, at least in part, on the client identity information.

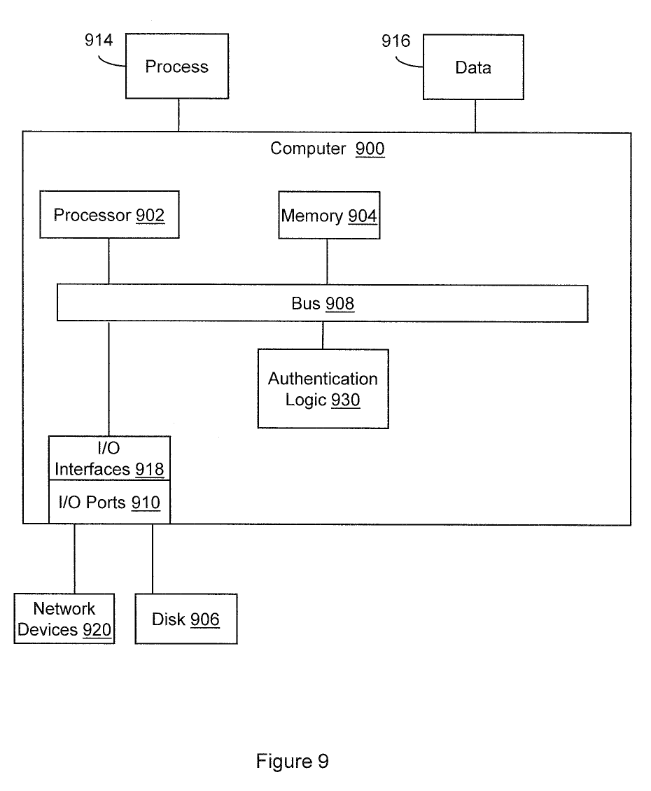

FIG. 9 illustrates an example computing device in which example systems and methods described herein, and equivalents, may operate. The example computing device may be a computer 900 that includes a processor 902, a memory 904, and input/output ports 910 operably connected by a bus 908. In one example, the computer 900 may include an authentication logic 930 configured to facilitate client identification for transportation layer security sessions. In different examples, the logic 930 may be implemented in hardware, software, firmware, and/or combinations thereof. While the logic 930 is illustrated as a hardware component attached to the bus 908, it is to be appreciated that in one example, the logic 930 could be implemented in the processor 902.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels can be used to create an operable connection.

“Hardware component”, as used herein, refers to a computer-related entity. Hardware components may include, for example, a process running on a processor, a processor, an object, an executable, and a thread of execution. A hardware component(s) may include a process and/or thread. A hardware component may be localized on one computer and/or may be distributed between multiple computers.

Logic 930 may provide means (e.g., hardware, software, firmware) for monitoring a first transport layer security (TLS) communication between a server and a client. The means may be implemented, for example, as an ASIC programmed to facilitate client identification for transportation layer security sessions. The means may also be implemented as computer executable instructions that are presented to computer 900 as data 916 that are temporarily stored in memory 904 and then executed by processor 902.

Logic 930 may also provide means (e.g., hardware, software, firmware) for causing the first TLS communication to be interrupted. Logic 930 may also provide means (e.g., hardware, software, firmware) for initiating a second TLS communication with a client side device associated with the client. This second TLS communication may be initiated within the same TCP connection as the first TLS communication. The second TLS communication requests a certificate from the client side device. The certificate may include secure information that identifies the client.

Logic 930 may also provide means (e.g., hardware, software, firmware) for receiving the certificate from the client side device. Logic 930 may also provide means (e.g., hardware, software, firmware) for controlling whether the client is granted an authorization to access the server based, at least in part, on the certificate. This may facilitate authentication and authorization of a request by the client for sensitive data in the server.

Generally describing an example configuration of the computer 900, the processor 902 may be a variety of various processors including dual microprocessor and other multi-processor architectures. A memory 904 may include volatile memory and/or non-volatile memory. Non-volatile memory may include, for example, ROM, programmable ROM (PROM), and so on. Volatile memory may include, for example, RAM, static RAM (SRAM), dynamic RAM (DRAM), and so on.

A disk 906 may be operably connected to the computer 900 via, for example, an input/output interface (e.g., card, device) 918 and an input/output port 910. The disk 906 may be, for example, a magnetic disk drive, a solid state disk drive, a floppy disk drive, a tape drive, a Zip drive, a flash memory card, a memory stick, and so on. Furthermore, the disk 906 may be a CD-ROM drive, a CD recordable (CD-R) drive, a CD rewriteable (CD-RW) drive, a digital versatile disk and/or digital video disk read only memory (DVD ROM), and so on. The memory 904 can store a process 914 and/or a data 916, for example. The disk 906 and/or the memory 904 can store an operating system that controls and allocates resources of the computer 900.

The bus 908 may be a single internal bus interconnect architecture and/or other bus or mesh architectures. While a single bus is illustrated, it is to be appreciated that the computer 900 may communicate with various devices, logics, and peripherals using other busses (e.g., peripheral component interconnect express (PCIE), 1394, universal serial bus (USB), Ethernet). The bus 908 can be types including, for example, a memory bus, a memory controller, a peripheral bus, an external bus, a crossbar switch, and/or a local bus.

The computer 900 may interact with input/output devices via the i/o interfaces 918 and the input/output ports 910. Input/output devices may be, for example, a keyboard, a microphone, a pointing and selection device, cameras, video cards, displays, the disk 906, the network devices 920, and so on. The input/output ports 910 may include, for example, serial ports, parallel ports, and USB ports.

The computer 900 can operate in a network environment and thus may be connected to the network devices 920 via the i/o interfaces 918, and/or the i/o ports 910. Through the network devices 920, the computer 900 may interact with a network. Through the network, the computer 900 may be logically connected to remote computers. Networks with which the computer 900 may interact include, but are not limited to, a LAN, a WAN, and other networks.

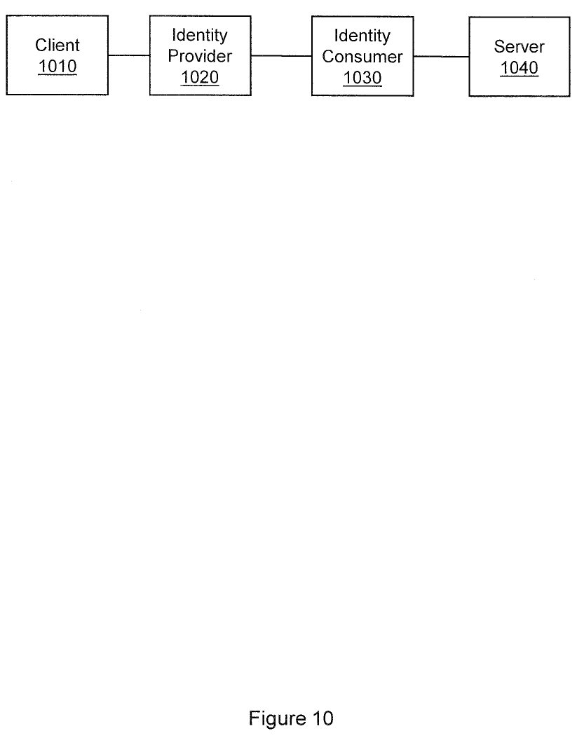

FIG. 10 illustrates an example environment where client identification for transport layer security involves an identity provider 1020 and an identity consumer 1030 processing an Internet Key Exchange (IKE). A client 1010 may initiate an IKE exchange to establish keys that will be used to create a secure tunnel to a server 1040. The client 1010 forms an initial exchange message that may be, for example, a main mode message, an aggressive mode message, an IKEv2 message, and so on.

The identity provider 1020 intercepts this message and modifies it by inserting a vendor identification payload. In different embodiments the contents of the vendor payload may vary based, for example, on sub-schemes described below. The identity provider 1020 then forwards the modified IKE message. The message that is modified may be a first message in an IKE exchange, a second message in an IKE exchange, or a later message in an IKE exchange. The message may be an encrypted message or an unencrypted message.

The identity consumer 1030 intercepts the modified IKE message and examines it for the vendor identification payload. If the vendor identification payload is located, the identity consumer 1030 determines the client identity. Based on the client identity, the identity consumer 1030 may take an action, for example, an access control decision. If the identity consumer 1030 decides to grant access, then the identity consumer 1030 may forward the IKE message to the server 1040. In one embodiment the identity consumer 1030 may not even remove the vendor identification payload. If an identity consumer 1030 is not present, the additional vendor identification payload has no effect on the IKE exchange.

In one environment, there may not be an identity provider 1020. In this example, the identity consumer 1030 may intercept an unmodified IKE message. The identity consumer 1030 will determine that no identity has been provided and thus will perform its security policy on unauthenticated communication.

A first sub-scheme occurs when the vendor identification contains the client identity. In this sub-scheme, the identity consumer 1030 can process the client identity directly without further communication from the identity provider 1020.

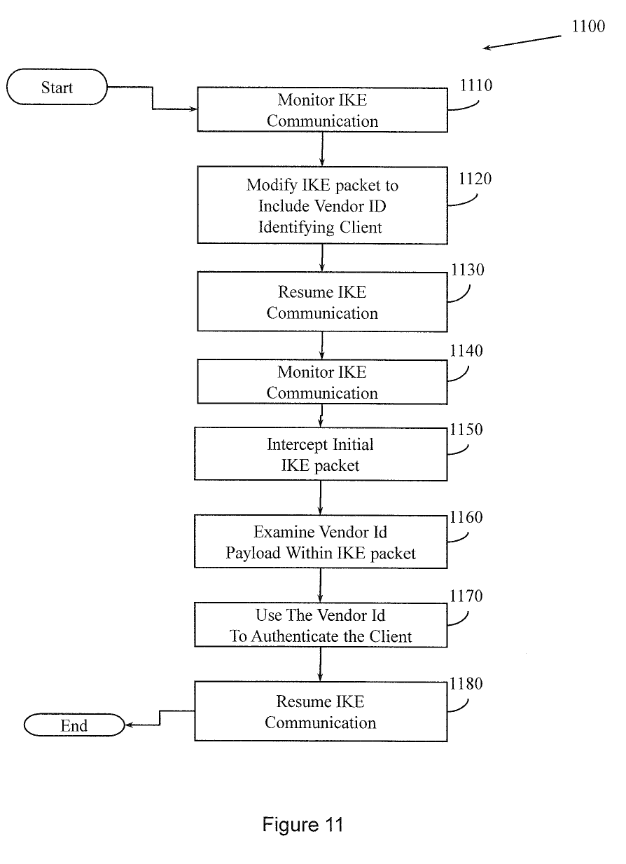

FIG. 11 illustrates a method 1100 associated with this first sub-scheme. Method 1100 may include, at 1110, monitoring a first IKE negotiation. In this sub-scheme, the vendor identification may include an MD5 hash identifying the vendor identification. This method may also involve modifying the in-process IKE negotiation by inserting a vendor identification at 1120. This vendor identification may include the client identity as encrypted by a key known to the identity consumer. In this sub-scheme the vendor identification may include the signature of the encrypted client identity and the key exchange identifier (KEI) payload in the same IKE message signed by the identity provider. Including the KEI payload in the signature ensures that the vendor identification cannot be extracted and applied to another message not generated by the original client. In this sub-scheme the vendor identification may include the certificate of the identity provider. Method 1100 may include, at 1130, the identity provider forwarding the IKE message. Method 1100 may include, at 1140, the identity consumer monitoring the initial IKE message, and at 1150, intercepting the IKE message. Method 1100 may include, at 1160, the identity consumer searching the IKE message for the vendor id. Method 1100 may include, at 1170, the identity consumer parsing the vendor identification, verifying the certificate, verifying that the signature validates, decrypting the client identity, and using that identity to perform an access control decision. Method 1100 may include, at 1180, the identity consumer allowing the IKE message to proceed if the access control decision allows the negotiation to proceed.

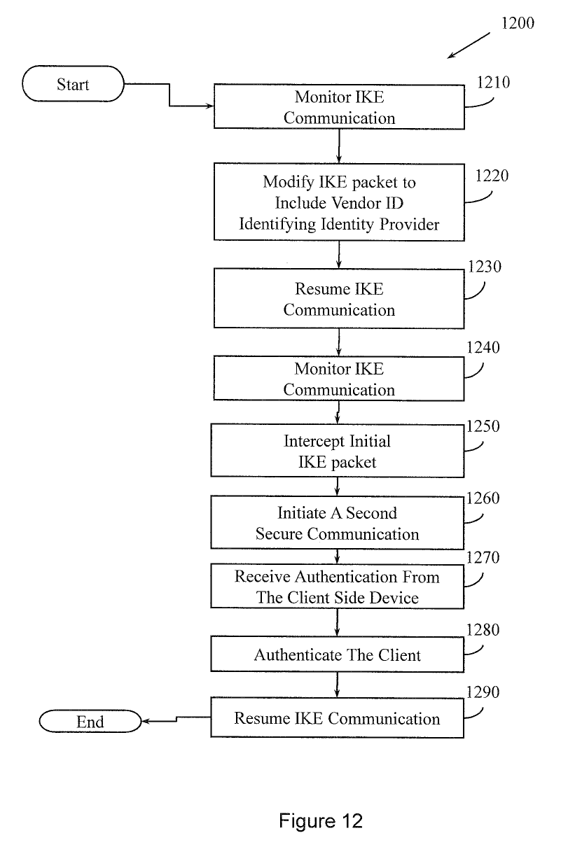

A second sub-scheme occurs when the vendor identification contains a point of contact to enquire about the identity. FIG. 12 illustrates a method 1200 associated with the second sub-scheme. Method 1200 may include, at 1210, monitoring a first IKE negotiation. Method 1200 may also involve modifying the in-process IKE negotiation by inserting a vendor identification at 1220. In this sub-scheme, the vendor identification may include the identity of the identity provider. Method 1200 may include, at 1230, the identity provider forwarding the IKE message. Method 1200 may include, at 1240, the identity consumer monitoring the initial IKE message, and at 1250, intercepting the IKE message. Method 1200 may include, at 1260, the identity consumer initiating a secure connection with the identity provider based on the information in the vendor identification. The secure connection may be established using, for example, an IKE message. Method 1200 may include, at 1270, the identity provider using this secure connection to provide the identity information to the identity consumer. One possible manifestation of this identity information may be a certificate. Method 1200 may include, at 1280, the identity provider using this identity information to make the access control decision. Method 1200 may include, at 1290, the identity consumer allowing the original IKE message to proceed if the access control decision allows the negotiation to proceed.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

What is claimed is:

1. A logic encoded in one or more tangible media for execution and when executed operable to perform a method, the method comprising:
monitoring a first transportation layer security (TLS) communication between a client and a server;
interrupting the first TLS communication and causing the first TLS communication to be deferred;
initiating a second TLS communication with a client side device, where the second TLS communication requests a certificate from the client side device, and where the certificate comprises secure information that identifies the TLS client performing the second TLS communication;
receiving the certificate from the client side device;
authenticating one or more of, the client, and the client side device, based, at least in part, on the certificate; and
resuming the first TLS communication.

2. The logic of claim 1, the method comprising:
intercepting and monitoring a TLS ClientHello from the client to the server; and
forwarding the TLS ClientHello to the server, where the forwarding continues the first TLS communication between the client and the server.

3. The logic of claim 1, where the first TLS communication is a TLS handshake and the second TLS communication is a TLS handshake.

4. The logic of claim 1, where the first TLC communication and the second TLS communication occur in the same TCP connection.

5. The logic of claim 1, where the method is performed by one or more of, the server, an application executing in the server, a firewall, and an authentication via monitoring (AvM) device associated with the server.

6. The logic of claim 1, where the client side device is one of, the client, a networking device associated with the client, an Ethernet switch associated with the client, a security agent associated with the client, and a security trust agent associated with the client.

7. The logic of claim 1, where the certificate is one or more of, a public key, a certificate issued by a third party that can be validated by the server or an AvM, a public key associated with the client side device, and a private key associated with the client side device.

8. The logic of claim 1, where the secure information that identifies the TLS client performing the second TLS communication is conveyed in one or more of, an attribute-value pair, a RADIUS message, and a container.

9. The logic of claim 1, the method comprising:
allowing the client to perform trusted communications with the server, where trusted communications comprise the server sending trusted information to the client.

10. A logic encoded in one or more tangible media for execution and when executed operable to perform a method, the method comprising:
requesting a TLS certificate from a client side associated with a client upon detecting a first transport layer security (TLS) ClientHello from the client, where requesting the TLS certificate comprises providing a TLS ServerHello, where the client side is one or more of, a client application, the client, an Ethernet switch, a security agent, and a trust agent, and where the TLS certificate identifies the client with one or more of, a public key, a private key, and a key issued by a trusted third party;
receiving a TLS Cancellation from the client side in response to requesting the TLS certificate;
receiving a second TLS ClientHello from the client side in response to requesting the TLS certificate;
requesting a TLS certificate from the client side upon receiving the second TLS ClientHello, where requesting the TLS certificate comprises sending a TLS ServerHello to the client side;
receiving a TLS certificate from the client side in response to requesting the TLS certificate from the client side;
sending a TLS ChangeCipher specification to the client side upon receiving the TLS certificate from the client side;
receiving a security information about the client in response to sending the TLS ChangeCipher specification;
deciding whether to grant the client access to a server based, at least in part, on the security information and the TLS certificate, where deciding whether to grant the client access to the server is performed in response to receiving the security information;
sending an authentication complete signal to the client side upon deciding whether to grant the client access to the server; and
sending a TLS ClientHello to the server upon sending the authentication complete signal to the client side.

11. An apparatus, comprising:
a monitor logic to monitor a first transport layer security (TLS) communication between a client and an identity consumer;
an identity logic to initiate a second TLS communication, where the second TLS communication is to establish a secure connection between the apparatus and the identity consumer, where the secure connection is used to pass an identity information associated with the client to the identity consumer; and
a receive logic to receive an authentication signal from the identity consumer, where the authentication signal is associated with authorizing the client to access the server.

12. The apparatus of claim 11, where the monitor logic is to cause the first TLS communication to be interrupted.

13. The apparatus of claim 11, where the first TLS communication is a TLS handshake, and where the second TLS communication is a TLS handshake.

14. The apparatus of claim 11, where the authentication signal is created by the identity consumer based, at least in part, on the identity information, and where the authentication signal is to indicate whether the client is authorized to connect to the server.

15. The apparatus of claim 11, where the apparatus is one or more of, a networking device associated with the client, located in the client, a firewall protecting the client, an Ethernet switch, a security agent, and a trust agent.

16. The apparatus of claim 11, where the monitoring logic is configured to collect a first TLS identity information of the client from the first TLS communication.

17. The apparatus of claim 11, where the monitoring logic is configured to resume the first TLS communication.

18. The apparatus of claim 16, where the identity logic is configured to pass the first TLS identity information to the identity consumer, and where the identity consumer is configured to determine whether to grant the client access to the server based, at least in part, on the identity information and the first TLS identity information.

19. The apparatus of claim 11, where the identity consumer is a firewall associated with the server, and where the identity consumer is one or more of, located between the apparatus and the server, and located in the server.

20. An apparatus, comprising:
a monitor logic to monitor a transport layer security (TLS) communication between a server and a client, where the monitor logic causes the TLS communication to be interrupted;
a client communication logic to initiate a CertificateRequest to a client side device and to receive a certificate from the client side device, where the certificate comprises a secure information that identifies the client;
an authorization logic to determine whether the client is granted an authorization to access the server based, at least in part, on the certificate; and
a control logic to selectively control communications between the server and the client based on the authorization granted by the authorization logic.

21. The apparatus of claim 20, where the client side device is one or more of, the client, a firewall protecting the client, an Ethernet switch, a security agent, and a trust agent.

22. The apparatus of claim 20, where the authorization logic is configured to determine whether the client is granted access to the server based, at least in part, on a TLS information monitored during the TLS communication.

23. The apparatus of claim 20, where the TLS communication is a TLS handshake, and where the CertificateRequest is one or more of, a TLS communication, and a TLS handshake.

24. The apparatus of claim 20, where the authorization logic is configured to send an authentication signal to the client side device, where the authentication signal is to indicate to the client side device whether the client is granted access to the server.

25. A system, comprising:
means for monitoring a first transport layer security (TLS) communication between a client and a server;
means for causing the first TLS communication to be interrupted;
means for initiating a second TLS communication with a client side device associated with the client, where the second TLS communication requests a certificate from the client side device, and where the certificate comprises secure information that identifies the client;
means for receiving the certificate from the client side device;
means for controlling whether the client is authorized to access the server based, at least in part, on the certificate; and
means for resuming the interrupted first TLS communication.

26. A logic encoded in one or more tangible media for execution and when executed operable to perform a method, the method comprising:
monitoring a security protocol negotiation between a client and a server;
selectively interrupting the security protocol negotiation; and
selectively providing an authentication possible signal to an authentication logic associated with the server before completing the security protocol negotiation.

27. The logic of claim 26, where the security protocol negotiation is associated with Transport Layer Security (TLS).

28. The logic of claim 26, where the security protocol negotiation is associated with Internet Key Exchange (IKE).

29. The logic of claim 26, the method comprising:
selectively controlling the security protocol negotiation to complete as a function of a client authentication initiated in response to the authentication possible signal.

30. The logic of claim 28, where selectively providing the authentication possible signal comprises modifying one or more of, an IKE packet, and an IKEv2 packet, to include a vendor id payload.

31. The logic of claim 30, where selectively interrupting a security protocol negotiation comprises:
examining one or more of, the IKE packet, and the IKEv2 packet for a vendor id payload, and selectively allowing the security protocol negotiation based, at least in part, on the existence and contents of the vendor id payload.

32. The logic of claim 30, where selectively interrupting a security protocol negotiation comprises:
interrupting one or more of, an IKE exchange, and an IKEv2 exchange;
negotiating a secure tunnel; and
validating authentication via the secure tunnel.
